(19) United States
(12) Patent Application Publication
(10) Pub. No.: US 2023/0048242 A1
(43) Pub. Date: Feb. 16, 2023

(54) DECENTRALIZED RIDESHARING SYSTEMS AND METHODS FOR MATCHING VEHICLES WITH USERS

(71) Applicant: Toyota Motor Engineering & Manufacturing North America, Inc., Plano, TX (US)

(72) Inventors: Boqi Li, Ann Arbor, MI (US); Nejib Ammar, San Jose, CA (US); Prashant Tiwari, Santa Clara, CA (US)

(73) Assignee: Toyota Motor Engineering & Manufacturing North America, Inc., Plano, TX (US)

(21) Appl. No.: 17/400,290

(22) Filed: Aug. 12, 2021

(51) Int. Cl. G06Q 10/06

(52) U.S. Cl. CPC G06Q 10/06311

(57) ABSTRACT

Decentralized ridesharing systems and methods for assigning a user request to a particular registered vehicle. The method includes organizing a geographic area into a plurality of geographic zones, each of the plurality of geographic zones serviced by a corresponding regional server, each regional server monitoring a location and a passenger status of one or more registered vehicles within a corresponding geographic zone, and allocating dispatching and ridesharing tasks between the regional servers and the one or more registered vehicles within each of the geographic zones, wherein the regional servers and the one or more registered vehicles are each equipped with decision-making modules powered by a graph neural network with reinforcement learning.

### TECHNICAL FIELD

The present specification generally relates to ridesharing systems and methods for matching registered vehicles with user requests and, more specifically, decentralized ridesharing systems and methods for matching registered vehicles with user requests to maximize the number of successfully completed user requests.

### BACKGROUND

App-based ridesharing services have proven to be an efficient and convenient door-to-door mobility solution. Pooled ridesharing services, such as those that assign multiple passengers to a single vehicle at the same time, are particularly attractive in comparison to private ridesharing services in which only a single user is assigned to a vehicle at any one time due to its better use of the vehicle and road recourses with relatively less traffic congestion, as well as reduction of mobility costs and emissions footprint. However, in either case, a user may be assigned to a vehicle or to a vehicle that already includes a passenger that does not meet the user's particular preferences. In addition, currently available ridesharing services fail to take into account maximizing the number of user requests that can be satisfied when multiple vehicles are capable of selecting the same user request.

Accordingly, a need exists for improved ridesharing systems that match a registered vehicle with a user request based on both a benefit to the particular registered vehicle, a benefit to a user associated with the user request, and a benefit to an entire fleet of registered vehicles.

### SUMMARY

In one embodiment, a method for assigning a user request to a registered vehicle includes organizing a geographic area into a plurality of geographic zones, each of the plurality of geographic zones serviced by a corresponding regional server, each regional server monitoring a location and a passenger status of one or more registered vehicles within a corresponding geographic zone, and allocating dispatching and ridesharing tasks between the regional servers and the one or more registered vehicles within each of the plurality of geographic zones, wherein the regional servers and the one or more registered vehicles are each equipped with decision-making modules powered by a graph neural network with reinforcement learning.

In another embodiment, a decentralized ridesharing system includes a controller configured to organize a geographic zone into a plurality of geographic zones, each of the plurality of geographic zones serviced by a corresponding regional server, each regional server monitoring a location and a passenger status of one or more registered vehicles within the corresponding geographic zone, and allocate dispatching and ridesharing tasks between the regional servers and the one or more registered vehicles within each of the plurality of geographic zones, wherein the regional servers and the one or more registered vehicles are each equipped with decision-making modules powered by a graph neural network with reinforcement learning.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a decentralized ridesharing system including a central server communicating with a plurality of regional servers, a plurality of registered vehicles, and a plurality of users provided on a map, according to one or more embodiments shown and described herein;

FIG. 2 schematically depicts a diagram indicating a plurality of user requests that can be selected by one or more registered vehicles, according to one or more embodiments shown and described herein;

FIG. 3 schematically depicts components of the decentralized ridesharing system including a registered vehicle, a regional server, the central server, and a mobile device, according to one or more embodiments shown and described herein;

FIG. 4 schematically depicts a controller of the registered vehicle of FIG. 3, according to one or more embodiments shown and described herein;

FIG. 5 schematically depicts a controller of the regional server of FIG. 3, according to one or more embodiments shown and described herein;

FIG. 6 schematically depicts a flowchart of an illustrative method for matching a user request with a registered vehicle, according to one or more embodiments shown and described herein; and

FIG. 7 schematically depicts a flowchart of an illustrative method for selecting which of two registered vehicles should be matched to a user request, according to one or more embodiments shown and described herein.

### DETAILED DESCRIPTION

Embodiments described herein are directed to ridesharing systems and methods for matching a registered vehicle with a particular user request. The methods for matching a user request to a registered vehicle include receiving a user request and allocating dispatching and ridesharing tasks between regional servers and one or more vehicles within a geographic zone. The regional servers and the one or more vehicles are each equipped with decision-making modules powered by a graph neural network with reinforcement learning to optimize the number of successfully completed user requests.

Various embodiments of the systems and methods and the operation of the systems are described in more detail herein. Whenever possible, the same reference numerals will be used throughout the drawings to refer to the same or like parts.

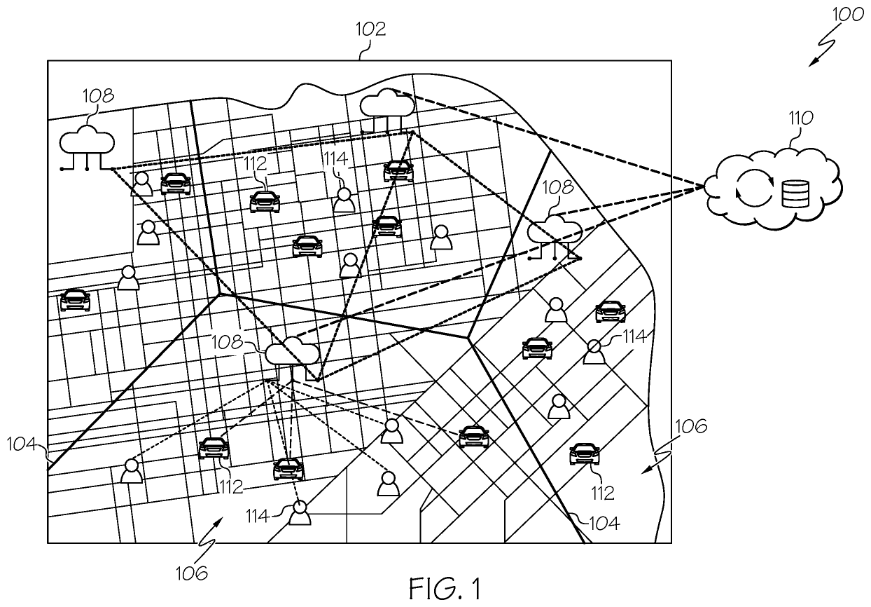

Referring now to FIG. 1, a schematic diagram of a decentralized ridesharing system 100 for assigning dispatching and ridesharing tasks to a plurality of registered vehicles to maximize the number of successfully completed user requests is illustrated.

As shown in FIG. 1, a map 102 includes a plurality of boundary lines 104 defining individual geographic zones 106. At least one regional server 108 is provided within each geographic zone 106 for monitoring activity within the particular geographic zone 106. Each regional server 108 may be, for example, an edge server for communicating directly with a central server 110 such as, for example, a cloud server.

As shown, a plurality of registered vehicles 112 are present within each geographic zone 106. Thus, each regional server 108 monitors the activity of the registered vehicles 112 within the geographic zone 106 of that regional server 108 in real time. In particular, each regional server 108 monitors a location and a passenger status of the registered vehicles 112 within the corresponding geographic zone 106. As a registered vehicle 112 leaves one geographic zone 106 and enters another geographic zone 106, the registered vehicle 112 is monitored by a different corresponding regional server 108 associated with the newly entered geographic zone 106. The passenger status monitored by the regional servers 108 indicates whether or not the particular registered vehicle 112 is currently transporting a passenger, how many passengers the registered vehicle 112 is currently transporting, the identity of those one or more passengers being transported by the registered vehicle 112, and the destination, i.e., drop off location, of the registered vehicle 112.

Each regional server 108 also monitors registered users, specifically, registered user devices operated by the users, within the geographic zone 106. More particularly, each regional server 108 receives a user request 114 from a user in the corresponding geographic zone 106. As used herein, a user request 114 is understood as including a request for the user to be picked up at a specific location and dropped off at a target destination. As discussed in more detail herein, the user request 114 or a user profile associated with the user may include one or more user preferences or parameters for dictating a suitable vehicle that may be matched to the particular user request 114. The one or more user parameters may include a max wait time for the vehicle, a max travel delay to a target destination, a personal matching score with a current passenger in the vehicle, and any other suitable user parameters for matching the user with a particular vehicle. In embodiments, the user parameters may be previously selected by the user. In embodiments, the user parameters may be learned over time based on previous user selections and previous trips by the user.

As shown, each regional server 108 communicates with the other regional servers 108 to transmit information related to the registered vehicles 112 and the registered users directly between the plurality of regional servers 108. Alternatively or in addition thereto, the information may also be shared indirectly with the plurality of regional servers 108 via the central server 110 such that each regional server 108 transmits the information to the central server 110 and the information may be subsequently transmitted to another regional server 108 either automatically or upon request from the regional server 108. The information may also be transmitted to a particular regional server 108 upon the central server 110 identifying a suitable registered vehicle 112 in the geographic zone 106 associated with the regional server 108 that should be matched to a user request 114.

It should be appreciated that by assigning a regional server 108 to each predefined geographic zone 106, the required time and processing power required to analyze data related to the registered vehicles 112 and registered users is less than that required by processing additional information outside of the geographic zone 106 that may be unnecessary for the specific user request 114 received from within the particular geographic zone 106. Additionally, by allocating a regional server 108 to each geographic zone 106 and individually communicating with the central server 110 to distribute the workload among the plurality of regional servers 108, the latency of data transmitted to the central server 110 is reduced.

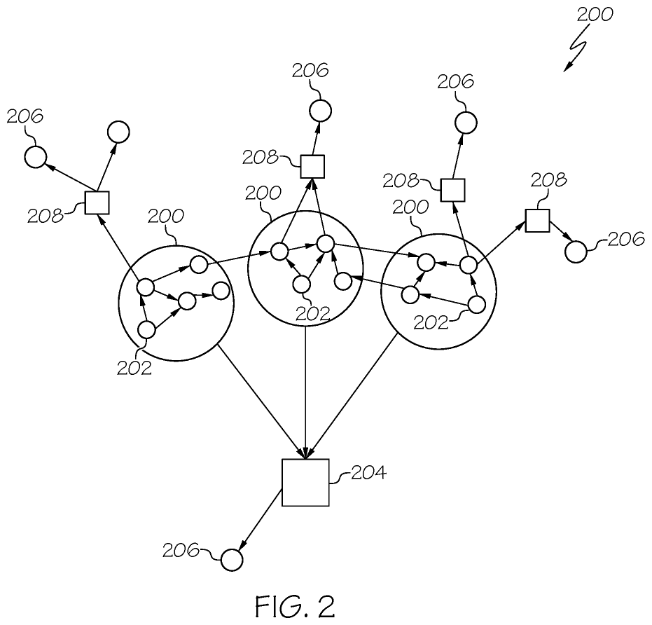

Referring now to FIG. 2, an exemplary diagram is illustrated indicating a plurality of candidate geographic zones 200, each including a plurality of candidate user requests 202 that may be selected by a target registered vehicle 204 of the plurality of registered vehicles 112 illustrated in FIG. 1. It should be appreciated that each registered vehicle 112 internally creates or is presented with a diagram, such as that illustrated in FIG. 2, for determining which candidate user request 202 to select. As used herein, the candidate geographic zones 200 refer to a subset of the plurality of geographic zones 106 (FIG. 1) that are presented to the target registered vehicle 204 in which a candidate user request 202 may be selected. Similarly, as used herein, the candidate user requests 202 refer to a subset of the total user requests 114 (FIG. 1) that are presented to the target registered vehicle 204 for matching.

Only those user requests that include one or more user parameters, such as max pick up/wait time, travel delays, cost, etc., that are satisfied by the target registered vehicle 204 are initially presented to the target registered vehicle 204. Any other user requests including one or more user parameters that are not satisfied by the target registered vehicle 204 are disregarded. Additionally, one or more current passengers 206 are illustrated associated with each of the target registered vehicle 204 and a plurality of other registered vehicles 208 of the plurality of registered vehicles 112 (FIG. 1). A link between the any passenger 206 and an associated registered vehicle 204, 208 indicates that the passenger 206 is on board that particular vehicle. A link between any two candidate user requests 202 indicates that the target registered vehicle 204 or another registered vehicle 208 is capable of picking up each user associated with those candidate user requests 202. For example, the users may be located along the same route to the destination of the passenger or one of the other users. As described herein, the decentralized ridesharing system 100 seeks to maximize the number of successfully completed user requests, i.e., dropping off users at their target destination, not only by the target registered vehicle, but by an entire fleet of registered vehicles including the subsequent vehicles. Thus, as discussed in more detail herein, the decentralized ridesharing system 100 optimizes which user requests should be assigned to the target registered vehicle 204, as well as the other registered vehicles 208 to ensure that maximum number of user requests are satisfied.

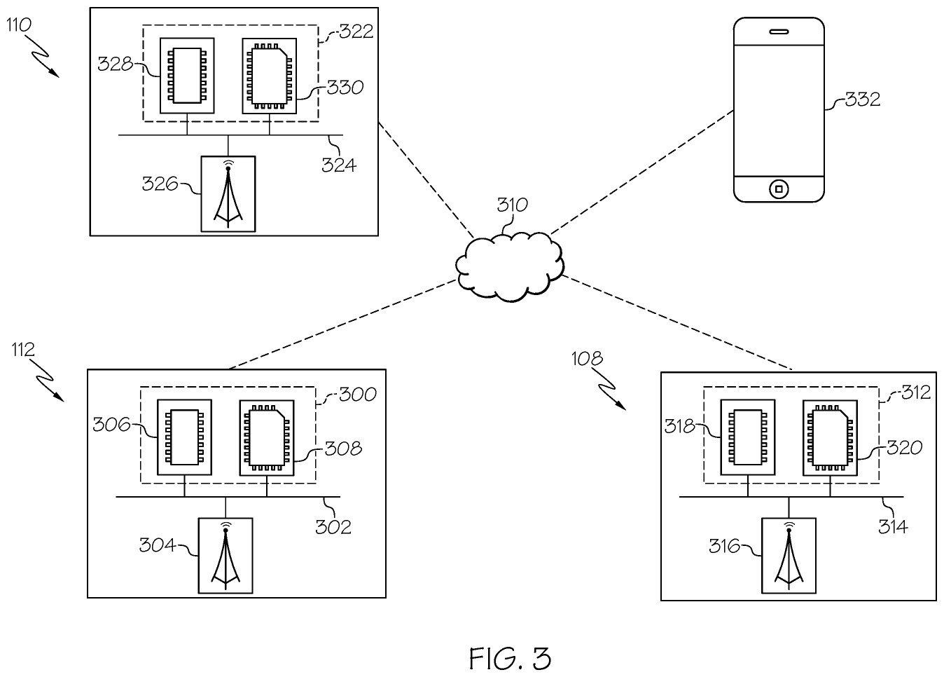

Referring now to FIG. 3, a schematic diagram of the decentralized ridesharing system 100 is depicted illustrating individual hardware components of one of the plurality of registered vehicles 112, one of the plurality of regional server 108, and the central server 110. It should be appreciated that each of the registered vehicles 112 includes the same structure and components. Similarly, it should be appreciated that each of the regional servers 108 includes the same structure and components. As such, only the structure and components of a single registered vehicle 112 and a single regional server 108 is discussed in detail herein.

In embodiments, the registered vehicle 112 includes a controller 300, a communication path 302, and network interface hardware 304. The communication path 302 may be formed from any medium that is capable of transmitting a signal such as, for example, conductive wires, conductive traces, optical waveguides, or the like. Moreover, the communication path 302 may be formed from a combination of mediums capable of transmitting signals. In one embodiment, the communication path 302 includes a combination of conductive traces, conductive wires, connectors, and buses that cooperate to permit the transmission of electrical data signals to components such as processors, memories, sensors, input devices, output devices, and communication devices. Accordingly, the communication path 302 may include a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 302 communicatively couples the various components of the registered vehicle. As used herein, the term “communicatively coupled” means that coupled components are capable of exchanging data signals with one another such as, for example, electrical signals via conductive medium, electromagnetic signals via air, optical signals via optical waveguides, and the like.

As noted above, the registered vehicle includes the controller 300 including the one or more processors 306 and one or more memory modules 308. Each of the one or more processors 306 may be any device capable of executing machine readable instructions. Accordingly, each of the one or more processors 306 may be an integrated circuit, a microchip, a computer, or any other computing device. The one or more processors 306 are communicatively coupled to the other components of the registered vehicle by the communication path 302. Accordingly, the communication path 302 may communicatively couple any number of processors with one another, and allow the modules coupled to the communication path 302 to operate in a distributed computing environment. Specifically, each of the modules may operate as a node that may send and/or receive data.

Each of the one or more memory modules 308 of the registered vehicle is coupled to the communication path 302 and communicatively coupled to the one or more processors 306. The one or more memory modules 308 may include RAM, ROM, flash memories, hard drives, or any device capable of storing machine readable instructions such that the machine readable instructions may be accessed and executed by the one or more processors 306. The machine readable instructions may include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 308. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

As noted above, the registered vehicle 112 includes the network interface hardware 304 for communicatively coupling the registered vehicle 112 with the regional server 108 via a network 310. The network interface hardware 304 is coupled to the communication path 302 such that the communication path 302 communicatively couples the network interface hardware 304 to other modules of the registered vehicle 112. The network interface hardware 304 may be any device capable of transmitting and/or receiving data via a wireless network. Accordingly, the network interface hardware 304 may include a communication transceiver for sending and/or receiving data according to any wireless communication standard. For example, the network interface hardware 304 may include a chipset (e.g., antenna, processors, machine readable instructions, etc.) to communicate over wireless computer networks such as, for example, wireless fidelity (Wi-Fi), WiMax, Bluetooth®, IrDA, Wireless USB, Z-Wave, ZigBee, or the like. In some embodiments, the network interface hardware 304 includes a Bluetooth® transceiver that enables the registered vehicle 112 to exchange information with a user device 332 such as, for example, a smartphone, via Bluetooth® communication.

The network 310 may include one or more computer networks (e.g., a personal area network, a local area network, or a wide area network), cellular networks, satellite networks and/or a global positioning system and combinations thereof. Accordingly, the registered vehicle 112 can be communicatively coupled to the network 310 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 3, the regional server 108 includes a controller 312, a communication path 314, and network interface hardware 316. The controller 312 includes one or more processors 318 and one or more memory modules 320. The components of the regional server 108 may be structurally similar to and have similar functions as the corresponding components of the registered vehicle 112 (e.g., the controller 312 corresponds to the controller 300, the communication path 314 corresponds to the communication path 302, and the network interface hardware 316 corresponds to the network interface hardware 304).

Still referring to FIG. 3, the central server 110 includes a controller 322, a communication path 324, and network interface hardware 326. The controller 322 includes one or more processors 328 and one or more memory modules 330. As with the regional server 108, the components of the central server 110 may be structurally similar to and have similar functions as the corresponding components of the registered vehicle 112 (e.g., the controller 322 corresponds to the controller 300, the communication path 324 corresponds to the communication path 302, and the network interface hardware 326 corresponds to the network interface hardware 304).

As shown in FIG. 3, a user device 332 such as, for example, a cell phone tablet, or other personal computing device operated by a registered user is illustrated for transmitting a user request to the regional server 108 within the same geographic zone as the user device 332. The user request may include a current location of the registered user, a target destination of the registered user, and one or more user parameters as discussed herein. As discussed in more detail herein, the user device 332 communicates with the regional server 108 to identify one or more registered vehicles to be matched with the user request.

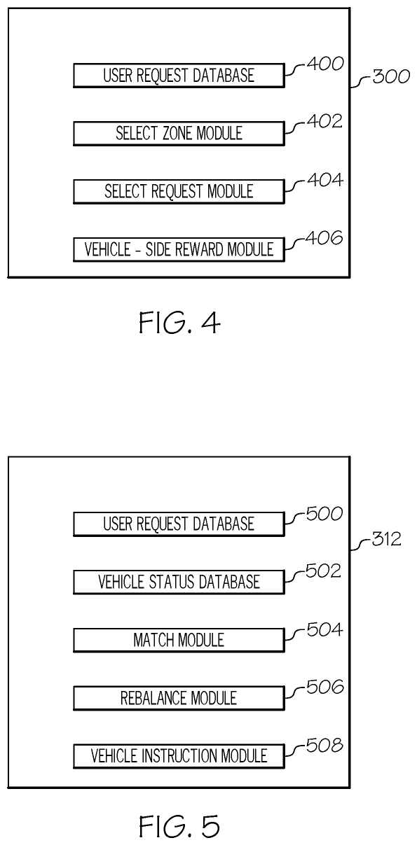

Now referring to FIG. 4, an exemplary controller 300 of the registered vehicle is shown. The controller 300 includes a user request database 400, a select zone module 402, a select request module 404, and a vehicle-side reward module 406. Each of the select zone module 402, the select request module 404, and the vehicle-side reward module 406 may be a program module in the form of operating systems, application program modules, and other program modules stored in the one or more memory modules 308. Such a program module may include, but is not limited to, routines, subroutines, programs, objects, components, data structures and the like for performing specific tasks or executing specific data types as will be described below.

The user request database 400 stores a plurality of user requests received from user devices operated by registered users. In embodiments, the user requests may be indirectly sent to a registered vehicle 112 via regional servers 108. As the user requests are received, those user requests having a pick up location and a target destination that can be satisfied by the registered vehicle 112 are transmitted to the registered vehicle 112. For example, a user request having a pick up location and/or a target destination along or within a threshold distance of a current route or potential route of the registered vehicle 112 are transmitted to the registered vehicle 112 and stored within the user request database 400. In addition to the current location and the target destination of the user, the user request includes the one or more user parameters discussed herein.

Upon receiving the user requests, a diagram, such as that illustrated in FIG. 2, is presented to the registered vehicle 112 to determine which geographic zone to select and which user request within the selected geographic zone to select. Specifically, the select zone module 402 determines which of the plurality of geographic zones 106 the registered vehicle 112 should be selected. The select zone module 402 may determine which of the plurality of geographic zones 106 to select based on the total number of user requests within that particular geographic zone 106. For example, the select zone module 402 may select a geographic zone having the greatest number of user requests. By selecting a geographic zone with the greatest number of user requests, the chances are greater of finding one or more user requests that can be matched with the registered vehicle 112 based on the user parameters associated with those user requests. In other embodiments, the select zone module 402 may select a geographic zone closest to a target destination of a current passenger of the registered vehicle 112 to increase the likelihood that the registered vehicle 112 will be able to pick up a registered user either prior to or shortly after dropping off the current passenger of the registered vehicle 112.

The select request module 404 determines which of the plurality of user requests within the particular geographic zone selected by the select zone module 402 to select. The select request module 404 selects one of the user requests within the selected geographic zone based on the user parameters associated with each of the user requests.

In addition, the particular user request is selected to optimize a vehicle-side reward function, specifically, to optimize the benefit to the registered vehicle 112 in selecting one of the user requests. The particular benefit could be a reduced distance to be traveled to the target destination, the ability to pick up multiple passengers along the same route, the payment to the registered vehicle 112 for selecting a particular user request, and the like. As such, the vehicle-side reward module 406 implements a graph neural network with reinforced learning to identify which user request provides the greatest benefit to the registered vehicle 112. In embodiments, the vehicle-side reward module 406 will rank and/or assign a score to a plurality of user requests so that if the user request providing the greatest benefit to the registered vehicle 112 is declined by the regional server 108 or the central server 110, discussed herein, the registered vehicle 112 may be able to identify the next user request to be selected.

With more particularity, the vehicle-side reward module 406 includes a graph neural network trained using reinforcement learning (GNN-RL) to emphasize maximizing the total number of served user requests while taking into consideration the vehicle-side reward function to benefit the registered vehicle 112. To train the graph neural network, the vehicle-side reward module 406 may be updated based on previously selected user requests, performance of the registered vehicle 112 after completing a selected user request, confirmation or denial of the selected user request by the regional server 108, and the like.

Referring now to FIG. 5, an exemplary controller 312 of the regional server 108 is shown. The controller 312 includes a user request database 500, a vehicle status database 502, a match module 504, a rebalance module 506, and a vehicle instruction module 508. Each of the match module 504, the rebalance module 506, and the vehicle instruction module 508 may be a program module in the form of operating systems, application program modules, and other program modules stored in the one or more memory modules 320. Such a program module may include, but is not limited to, routines, subroutines, programs, objects, components, data structures and the like for performing specific tasks or executing specific data types as will be described below.

The user request database 500 includes a plurality of current user requests received at the regional server 108 from user devices operated by registered users. Contrary to the user request database 400 of the controller 300 of the registered vehicle 112, which only includes those user requests including user parameters satisfied by the registered vehicle 112, the user request database 500 of the controller 312 of the regional server 108 includes all user requests for those users within the particular geographic zone of the regional server 108. The user requests may be sent directly to the regional server 108 within the same geographic zone as the user request and stored within the user request database 500 of the regional server 108. In embodiments, the user request database 500 may include requests or orders received from a different regional server 108 for those registered users in a different geographic zone.

The vehicle status database 502 includes the current status of each of the registered vehicles 112 within the particular geographic zone of the regional server 108. Within the vehicle status database 502, details for each of the registered vehicles 112 are stored such as, for example, whether or not the particular registered vehicle 112 is currently transporting a passenger, how many passengers the registered vehicle 112 is currently transporting, the destination of the registered vehicle 112, and the identity of those one or more passengers being transported by the registered vehicle 112. The current status of each of the registered vehicles 112 may be sent directly to the regional server 108 in the same geographic zone as the registered vehicle 112 and stored within the vehicle status database 502 of the regional server 108. In embodiments, the vehicle status database 502 may include a current status of a registered vehicle 112 received from a different regional server 108 for those registered vehicles 112 in a different geographic zone.

After the select zone module 402 and the select request module 404 of the controller 300 of the registered vehicle 112 have identified and selected a user request, the match module 504 of the regional server 108 confirms whether the user request should be assigned to the registered vehicle 112. The match module may confirm that the user request should be assigned to the registered vehicle 112 if the particular registered vehicle 112 is the most suited to pick up the user associated with the user request compared to the other registered vehicles. The match module 504 makes this determination based on a user-side reward function. As such, the match module 504 compares the benefit to the user of the user request by assigning the user request to one registered vehicle over another registered vehicle. If the match module 504 confirms that the user request should be assigned to the registered vehicle 112, the regional server 108 will provide the registered vehicle 112 with instructions to pick up the user associated with the user request, as described in more detail herein. Alternatively, if the match module 504 declines that the user request should be assigned to the registered vehicle 112, the registered vehicle may be assigned to another user request or directed to a different geographic zone, i.e., rebalanced.

Upon declining the user request to be matched to the registered vehicle 112 and determining that there is no other suitable user request for the registered vehicle 112, the rebalance module 506 may determine that the registered vehicle 112 should be directed to a different geographic zone. In embodiments, the rebalance module 506 may determine that the registered vehicle 112 should be directed to a different geographic zone based on a high demand of user requests within a specific geographic zone or, in other embodiments, a low supply of registered vehicles 112.

As noted above, the registered vehicle 112 may be instructed to pick up a user associated with a particular user request if the selected user request is approved, or may be directed to a different geographic zone if the selected user request is declined. In either instance, the vehicle instruction module 510 operates to transmit instructions, such as navigation instructions, to the registered vehicle 112. The navigation instructions may be displayed on, for example, a display screen of the registered vehicle 112.

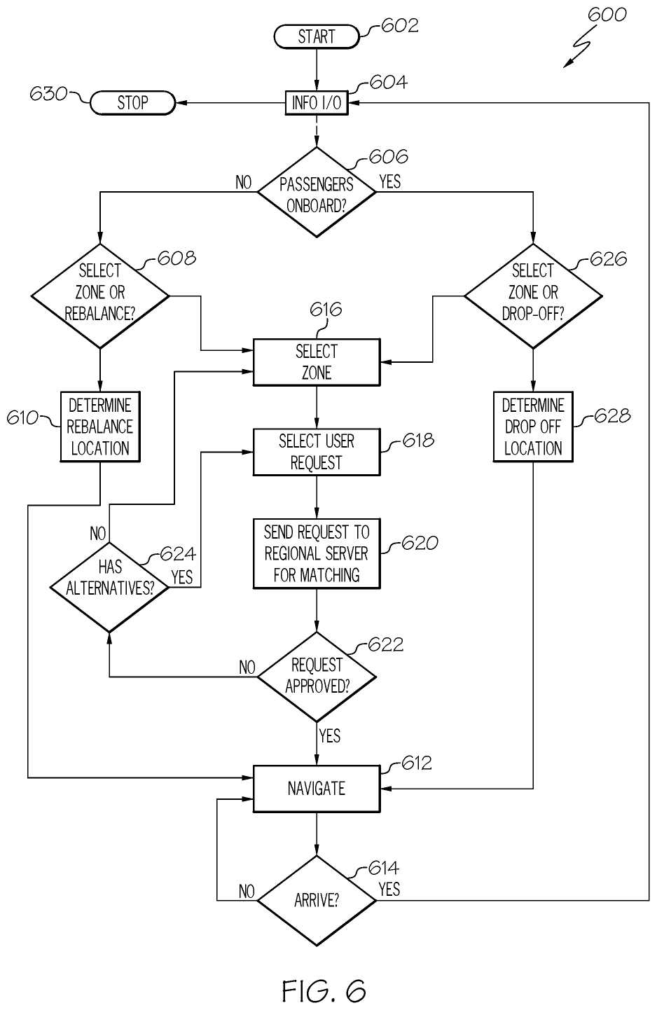

Referring now to FIG. 6, a method 600 is depicted for assigning instructions, such as user/passenger pick up instructions or relocating/rebalancing instructions. The method 600 is discussed with reference to the decentralized ridesharing system 100 and individual components thereof illustrated in FIGS. 1-5.

At step 602, the method 600 starts such as by activating a ridesharing service on the registered vehicle 112 indicating that the registered vehicle 112 wishes to be matched with a user request. Activating the ridesharing service may include starting the registered vehicle 112 and/or starting a software application on a mobile device for communicating with the regional server 108 in the same geographic zone 106 as the registered vehicle 112.

At step 604, user data and registered vehicle data is transmitted between the registered vehicle 112 and the regional server 108 within the geographic zone 106 in which the registered vehicle 112 is located. More particularly, the regional server 108 in the same geographic zone 106 as the registered vehicle 112 may receive, for example, user requests 114 from user devices in the geographic zone 106, data on registered vehicles within the geographic zone 106, and additional information, such as user requests and information on registered vehicles 112 from regional servers 108 of different geographic zones 106, such as adjacent geographic zones. The user requests and registered vehicle data received at the regional server 108 are stored in the user request database 500 and the vehicle status database 502, respectively. Additionally, at step 604, the registered vehicle 112 may receive, for example, user requests from user devices in the geographic zone 106 via the regional server 108 and information on other registered vehicles 112 via the regional server 108. The user requests received at the registered vehicle 112 are stored in the user request database 400.

At step 606, the registered vehicle 112 determines whether a passenger is on board the registered vehicle 112. If the registered vehicle 112 determines that no passenger is on board, the method 600 proceeds to step 608 at which a determination is made as to whether select a geographic zone or rebalance. If it is determined to rebalance, the method 600 proceeds to step 610 to determine a rebalance location using the rebalance module 506 of the regional server 108. After a rebalance location is determined at step 610, navigation instructions are determined by the vehicle instruction module 510 of the regional server 108 and sent to the registered vehicle 112 at step 612 to direct the registered vehicle 112 to the rebalance location. At step 614, the registered vehicle 112 determines whether it has arrived at the rebalance location. If so, the method 600 returns to step 604 to continue receiving updated user data. If not, the method 600 returns to step 612 to continue providing navigation instructions until the registered vehicle 112 arrives at the rebalance location.

Referring again to step 608, if it is determined that a geographic zone should be selected, the method 600 proceeds to step 616 to select a geographic zone of the plurality of geographic zones 106. As discussed herein, the select zone module 402 of the registered vehicle 112 selects a particular geographic zone 106. Once the geographic zone 106 is selected at step 616, a user request within the particular geographic zone 106 is selected by the select request module 404 of the registered vehicle 112, as discussed herein. Specifically, the geographic zone 106 and the user request are selected by the select zone module 402 and the select request module 404, respectively, by utilizing the GNN-RL of the vehicle-side reward module 406 to maximize the total number of served user requests while taking into consideration the vehicle-side reward function to benefit the registered vehicle 112.

After a user request is selected, the selected user request is transmitted to the regional server 108 to confirm or decline the selection of the registered vehicle 112 using the match module 504 of the regional server 108 at step 620. At step 622, a determination is made as to whether the selection is approved or declined. If the selection is declined, the method 600 proceeds to step 624 to determine whether alternative user requests were present within the geographic zone 106 selected by the registered vehicle 112 at step 616. If there are other user requests within the selected geographic zone 106, the method 600 returns to step 618 to select a different user request. If there are no other user requests within the selected geographic zone 106, the method 600 returns to step 616 to select a different geographic zone 106. Alternatively, if the user request is approved at step 622, the method proceeds to step 612 and the registered vehicle 112 is presented with navigation instructions directing the registered vehicle to the geographic zone 106.

Referring again to step 606, if the registered vehicle 112 determines that there are one or more passengers onboard the registered vehicle 112, the method 600 proceeds to step 626 to determine whether to select a geographic zone or drop off the current one or more passengers. If it is determined that one or more additional passengers may be picked up by the registered vehicle 112, the method 600 proceeds to step 616 and a geographic zone is selected. Alternatively, if it is determined that one or more additional passengers cannot be picked up by the registered vehicle 112 and thus the current one or more passenger should be dropped off, the drop off location is determined at step 628. Thereafter, navigation instructions are sent to the registered vehicle 112 at step 612 to navigate the registered vehicle 112 to the drop off location.

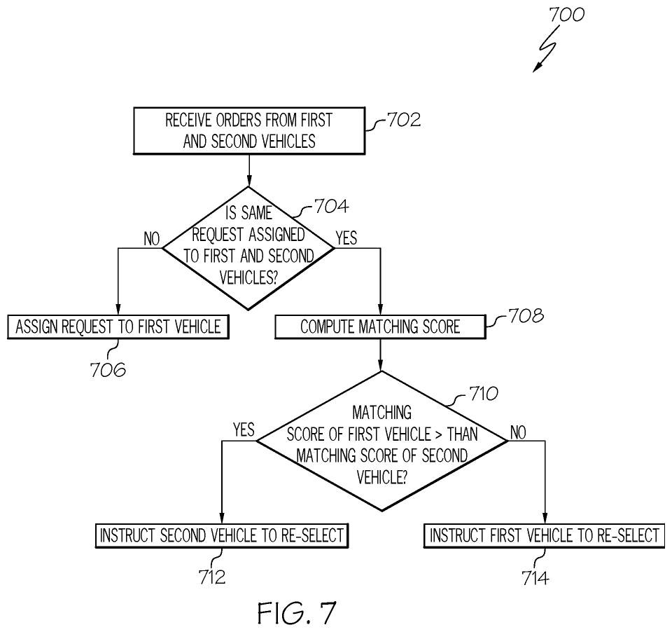

Referring now to FIG. 7, a method 700 is depicted for determining which of two competing registered vehicles should be assigned to a common user request. It should be appreciated that the present method 700 takes place at step 622 in FIG. 6. The method 700 is discussed with reference to the decentralized ridesharing system 100 and individual components thereof illustrated in FIGS. 1-5.

At step 702, a regional server 108 receives an order from the registered vehicle 112 to pick up a user associated with the selected user request. At step 702, the regional server 108 also receives an order from another or second vehicle to pick up a user associated with a user request. At step 704, it is determined whether the order received from second registered vehicle includes details for picking up the user associated with the same user request selected by the first registered vehicle 112. If not, the order received by the first registered vehicle 112 to pick up the user is approved at step 706. Alternatively, if the first registered vehicle 112 and the second registered vehicle both request to pick up the same user, a matching score is computed for both the first registered vehicle 112 and the second registered vehicle at step 708. The matching score is determined based on the benefit to both first registered vehicle 112 and the second registered vehicle, as well as the user associated with the user request, to maximize the number of user requests that can be successfully completed by the registered vehicles 112. At step 710, if it is determined that the matching score of the first registered vehicle 112 is greater than the matching score of the second registered vehicle, the method 700 proceeds to step 712 to instruct the second registered vehicle to select a different user request, as discussed in step 624 of FIG. 6. Alternatively, if it is determined that the matching score of the first registered vehicle 112 is less than the matching score of the second registered vehicle, the method 700 proceeds to step 714 to instruct the first registered vehicle to select a different user request.

From the above, it is to be appreciated that defined herein is a decentralized ridesharing system and method for assigning user requests to a registered vehicle. Specifically, the method for assigning a user request to a registered vehicle includes receiving user requests and allocating dispatching and ridesharing tasks between regional servers and one or more registered vehicles within each of a plurality of geographic zones. The regional servers and the one or more vehicles are each equipped with decision-making modules powered by a graph neural network with reinforcement learning to optimize the number of successfully completed user requests.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for assigning a user request to a registered vehicle comprising:
organizing a geographic area into a plurality of geographic zones, each of the plurality of geographic zones serviced by a corresponding regional server, each regional server monitoring a location and a passenger status of one or more registered vehicles within a corresponding geographic zone; and
allocating dispatching and ridesharing tasks between the regional servers and the one or more registered vehicles within each of the plurality of geographic zones,
wherein the regional servers and the one or more registered vehicles are each equipped with decision-making modules powered by a graph neural network with reinforcement learning.

2. The method of claim 1, wherein allocating dispatching and ridesharing tasks comprises:
identifying, by a registered vehicle of the one or more registered vehicles, a geographic zone of the plurality of geographic zones; and
identifying, by the registered vehicle, a user request of a plurality of user requests within the geographic zone.

3. The method of claim 2, wherein the geographic zone and the user request are determined such that a number of satisfied user requests performed by the registered vehicle is maximized.

4. The method of claim 2, wherein a regional server servicing the geographic zone in which the registered vehicle is located either:
confirms the user request in response to determining that one or more user parameters are satisfied; or
declines the user request in response to determining that one or more user parameters are not satisfied.

5. The method of claim 4, wherein the one or more user parameters includes one or more of a wait time for the registered vehicle, a travel delay to a destination, and a personal matching score with a current passenger in the registered vehicle.

6. The method of claim 4, wherein, in response to the regional server declining the user request, the registered vehicle is dispatched to a different geographic zone of the plurality of geographic zones.

7. The method of claim 4, wherein, in response to the regional server confirming the user request to the registered vehicle and receiving a signal that another registered vehicle of the one or more registered vehicles selects the user request, computing a matching score of the registered vehicle and a matching score of the another registered vehicle.

8. The method of claim 7, wherein, in response to determining that the matching score of the registered vehicle is greater than the matching score of the another registered vehicle, instructing the another registered vehicle to select a different user request of the plurality of user requests.

9. The method of claim 7, wherein, in response to determining that the matching score of the registered vehicle is less than the matching score of the another registered vehicle, assigning the user request to the another registered vehicle and instructing the registered vehicle to select a different user request of the plurality of user requests.

10. The method of claim 1, wherein each of the plurality of regional servers:
collects user data for registered users and registered vehicle data for the one or more registered vehicles within each corresponding geographic zone; and
upon receiving a request from a registered vehicle, transmit the collected user data and the registered vehicle data to the registered vehicle.

11. A decentralized ridesharing system comprising:
a controller configured to:
organize a geographic zone into a plurality of geographic zones, each of the plurality of geographic zones serviced by a corresponding regional server, each regional server monitoring a location and a passenger status of one or more registered vehicles within the corresponding geographic zone; and
allocate dispatching and ridesharing tasks between the regional servers and the one or more registered vehicles within each of the plurality of geographic zones,
wherein the regional servers and the one or more registered vehicles are each equipped with decision-making modules powered by a graph neural network with reinforcement learning.

12. The decentralized ridesharing system of claim 11, wherein the controller is further configured to:
receive, from a registered vehicle of the one or more registered vehicles, a geographic zone of the plurality of geographic zones; and
receive, from the registered vehicle, a user request of a plurality of user requests within the geographic zone.

13. The decentralized ridesharing system of claim 12, wherein the geographic zone and the user request are determined such that a number of satisfied user requests performed by the registered vehicle is maximized.

14. The decentralized ridesharing system of claim 12, wherein the controller is further configured to either:
confirms the user request in response to determining that one or more user parameters are satisfied; or
declines the user request in response to determining that one or more user parameters are not satisfied.

15. The decentralized ridesharing system of claim 14, wherein the one or more user parameters includes one or more of a wait time for the registered vehicle, a travel delay to a destination, and a personal matching score with a current passenger in the registered vehicle.

16. The decentralized ridesharing system of claim 14, wherein, in response to the controller declining the user request, the controller is further configured to instruct the registered vehicle to be dispatched to a different geographic zone.

17. The decentralized ridesharing system of claim 14, wherein, in response to the controller confirming the user request to the registered vehicle and receiving a signal that another registered vehicle of the one or more registered vehicles selects the user request, the controller is further configured to compute a matching score of the registered vehicle and a matching score of the another registered vehicle.

18. The decentralized ridesharing system of claim 17, wherein the controller is further configured to, in response to determining that the matching score of the registered vehicle is greater than the matching score of the another registered vehicle, instruct the another registered vehicle to select a different user request.

19. The decentralized ridesharing system of claim 17, wherein the controller is further configured to, in response to determining that the matching score of the registered vehicle is less than the matching score of the another registered vehicle, assign the user request to the another registered vehicle and instruct the registered vehicle to select a different user request.

20. The decentralized ridesharing system of claim 11, wherein the controller is further configured to:
collect user data for registered users and registered vehicle data for the one or more registered vehicles within each corresponding geographic zone; and
upon receiving a request from the registered vehicle, transmit the collected user data and the registered vehicle data to the registered vehicle.
